(19) United States
(12) Patent Application Publication
(10) Pub. No.: US 2007/0144898 A1
(43) Pub. Date: Jun. 28, 2007

(54) Cell for electrochemical processes

(76) Inventors: Dario Oldani, Milan (IT); Giorgio Minoia, Milan (IT); Leonello Carrettin, Milan (IT); Paolo Rossi, Milan (IT)

Correspondence Address: HEDMAN & COSTIGAN P.C., 1185 AVENUE OF THE AMERICAS, NEW YORK, NY, 10036, US

(21) Appl. No.: 10/587,962

(22) PCT Filed: Mar. 2, 2005
(86) PCT No.: PCT/EP05/02203

§ 371 Date: Jul. 31, 2006

(30) Foreign Application Priority Data
Mar. 4, 2004 (IT) MI2004A000408

(51) Int. Cl. B23H 3/04

(52) U.S. Cl. 204/286.1

(57) ABSTRACT

It is described a finite interelectrodic gap-cell for oxygen evolving-electrochemical processes comprising a package of planar anodes secured to a rack and a package of planar cathodes intercalated to the anodes secured to a frame. The cathode package can be handled separately or jointly with the anode package by means of a lifting device. The cell is particularly useful in metal electrowinning processes and in softening processes of calcareous waters by microelectrolysis.

### FIELD OF THE INVENTION

The invention is relative to an undivided cell for electrochemical processes with anodic oxygen evolution; in particular, the cell may be employed in processes of metal electrowinning or in industrial water treatments, for instance drinkable water softening.

### STATE OF THE ART

Several processes at low current density (lower than 0.5-1 kA/m²) are known, in the field of industrial electrochemistry, whose anodic reaction leads to oxygen evolution; such type of applications, contrarily to other common electrochemical processes, wherein the use of high current densities and/or the evolution of noxious and corrosive gases such as chlorine have imposed since some time a very accurate development of the relevant cell design, are carried out, as the current state of the art, in open basins of generic shape, in which single individually handled electrodes are housed. This is the case for example of electrometallurgical depositions from baths obtained from the attack of metal ores (electrowinning and the like): in this case, the poor dimensional stability of the lead anodes commonly used for the oxygen evolution, besides that of the cathodes wherein the metal coating constituting the required product grows, leads to the natural development of cells in which the flexibility in electrode positioning and in the individual regulation of the interelectrodic gap at different process stages represents a sensible benefit. However, especially the introduction of dimensionally stable anodes of titanium activated with catalytic paints as a replacement for the more widespread lead anodes makes now desirable a reconsideration of the traditional electrowinning cell geometry, allowing for a higher efficiency and productivity of the cells for deposition for a quicker pay-back of the greater costs of such new generation anodes. In particular, the market requires a novel cell design allowing to take advantage of the most advantageous feature of the new titanium anodes, that is the lower cell voltage, in order to make its introduction more profitable even at a higher investment cost. At the particularly reduced current densities characterising this kind of processes (0.2-0.5 kA/m²) the task is certainly not an easy one.

Several other examples of oxygen-evolving low current density electrochemica processes requiring novel cell designs can be set forth especially in the field of water treatment. A particularly relevant example is the softening of calcareous waters by microelectrolysis. Calcareous water microelectrolysis allows the cathodic deposition of calcium and/or magnesium carbonate by local shifting of the equilibrium between the carbonate and bicarbonate ionic species; the local cathode alkalinisation stemming from the electrolysis process which, due to the very poor electrolyte conductivity, is carried out at a minimum current density (in any case lower than 20 A/m², and usually below 1 A/m²) causes the local conversion of bicarbonate into carbonate ions, precipitating upon the cathode surface as scarcely soluble calcium and/or magnesium carbonate. This process disclosed in patent application FR 2 743 800, is a very strong competitor to the chemical (with caustic soda in the presence of sands or with lime milk) or physical type (with ion-exchange resins) softening treatments, especially in the field of waters for alimentary use. The cost of this process is nevertheless very high, due to the poor efficiency of the cylindrical reactors currently used for this purpose and described in the cited French patent application.

It is an object of the present invention to provide an electrochemical cell for oxygen-evolving low current density processes overcoming the limitations of the prior art. In particular, it is an object of the present invention to provide an electrochemical cell for oxygen-evolving low current density processes, for instance metal electrowinning or drinkable water treatment processes, showing optimum characteristics in terms of electrical efficiency, productivity per plant area, operating flexibility and handling and maintenance facility.

### THE INVENTION

Under one aspect, the invention consists of an electrochemical cell suitable for being crossed by an upward electrolyte flow, comprising an anode package and a cathode package mutually intercalated. The cathode package consists of a row of vertical planar cathodes, secured to a cathode frame, preferably in two upper points; the anode package consists of a row of vertical planar anodes preferably secured in at least two upper and two lower points to an anode rack, bolted in its turn to the cathode frame or otherwise fixed thereto in a reversible fashion. The cathode frame is suitable for being handled through an appropriate lifting means (for instance a derrick or a gantry crane) in order to allow the positioning of the whole cathode package in a single operation. Furthermore, the possibility of reversibly fixing the anode rack to the cathode frame makes possible handling either the cathode package alone or both of the electrodic packages at a time. In a preferred embodiment, the planar cathodes consist of stainless steel or nickel sheets. In a particularly preferred embodiment, the anodes consist of sheets of valve metal, preferably titanium, covered with a catalytic coating for oxygen evolution.

The cell of the invention may be delimited by a basin suited to contain the anode and cathode packages, or by containing side-walls, for instance bolted or otherwise secured to the anode rack. In the latter case, the cell is not provided with an own bottom, and is positioned on an appropriate collecting basin, for instance a conic bottom hopper tank, present on site. This solution is typically suitable for water treatment plants, for example for calcareous water softening, and in general for those cases wherein a powdery-type cathode product must be eliminated, which is advantageously collected on the tank bottom.

In a preferred embodiment, the cell of the invention comprises an anode bus-bar and a cathode bus-bar, preferably in the upper zone. The cathode bus-bar preferably concerns the zone of fixing of the cathodes to the cathode frame.

In a preferred embodiment, the anode and cathode package positioning according to an intercalated geometry is facilitated by suitable guides of insulating material, preferably plastic guides fixed to the anode rack, where the cathodes can be fitted in the assembly phase.

Under a further aspect, the invention is relative to a metal electrowinning process carried out by electrolysis in a bath containing the ions of the metal to be deposited in an electrochemical cell comprising an anode package and a cathode package, respectively comprising vertical anodes and cathodes reciprocally intercalated.

Under a further aspect, the invention is relative to a calcareous water softening process by microelectrolysis in an electrochemical cell comprising an anode package and a cathode package, respectively comprising vertical anodes and cathodes reciprocally intercalated.

The invention will be described making reference to the appended figures, provided for the simple sake of example and which shall not be intended as a limitation of the same.

### BRIEF DESCRIPTION OF THE FIGURES

FIG. 1 is a top-view of the cell of the invention;

FIG. 2 is a front-view of a cathode of the cell of the invention;

FIG. 3 is a side-view of a first embodiment of the cell of the invention;

FIG. 4 is a side-view of a second embodiment of the cell of the invention.

### DETAILED DESCRIPTION OF THE FIGURES

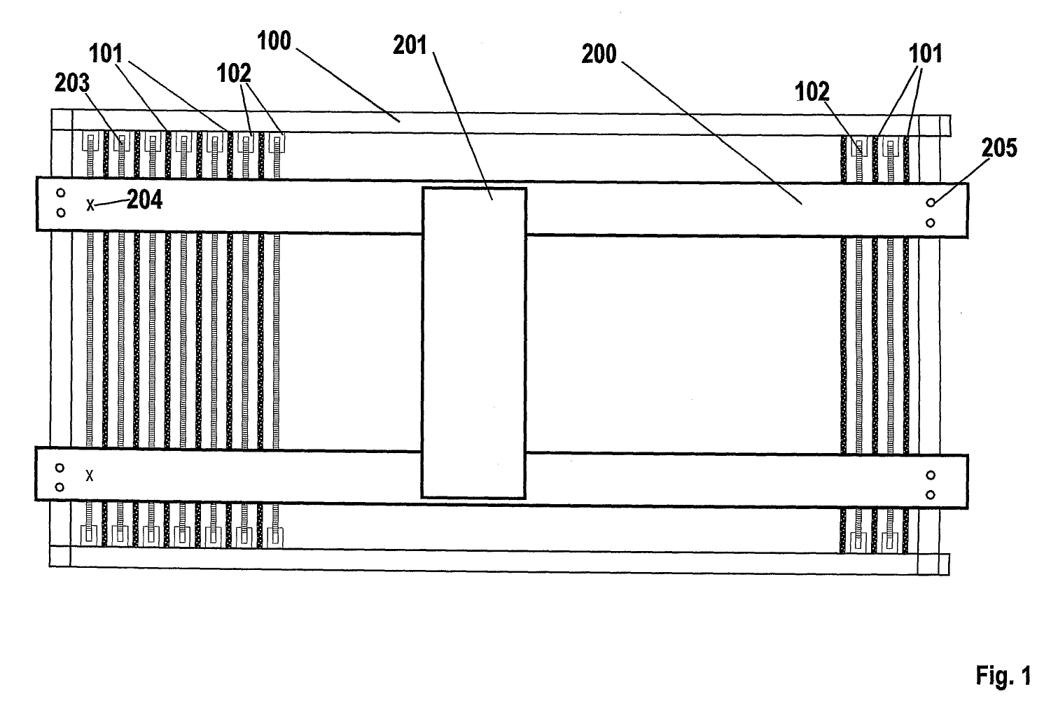

In FIG. 1 it is shown a top-view of the cell of the invention, whose external containing basin is not represented. The cell comprises an anode rack (100) whereto an anode package is secured consisting of a row of planar anodes (101), for example titanium anodes with a noble metal oxide-based catalytic coating for oxygen evolution, as known in the art. The anodes (101) are preferably perforated structures, such as meshes or expanded sheets. The rack (100) comprises also a series of insulating guides (102), for instance made of plastic material, suitable for favouring the correct insertion of the cathodes in an intercalated position to the anodes (101).

Overlaid to the anode package, a cathode package is shown secured to a frame, whose upper longitudinal bars (200) and an upper transversal bar (201) are shown. The number of longitudinal and transversal bars making up the cathode frame may however change according to the overall cell dimensions. To the cathode frame and in particular, according to the embodiment shown in the figure, to the longitudinal bars (200), a row of planar cathodes (203), is secured, for instance consisting of stainless steel or nickel solid sheets. The fixing points of one cathode (203) to the cathode frame are represented by crosses (204); the figure thus shows that each cathode is secured to the cathode frame in two upper points, one per each longitudinal bar (200). One skilled in the art can find several different satisfying solutions to secure the cathode package to the relevant frame, but the solutions providing at least two upper fixing points and at least two lower fixing points are preferred.

The positioning of the anodic and cathodic packages as shown in the figure, with no interposed diaphragm, determines a finite interpolar gap undivided-type cell geometry; the interpolar gap, which determines a large part of the ohmic drop and hence of the resistive penalty of the electrochemical process, can be maintained at extremely low values thanks to the kind of construction which may be accomplished with very restricted tolerances. In the case of metal electrodeposition processes, the minimum interpolar gap is limited by the need of preventing the product accumulating on the cathode from touching the facing anode even in an occasional fashion, determining local short-circuiting phenomena. In the cases of processes producing non-conductive cathodic deposits, as in the case of water microelectrolysis, such a constraint is less stringent, and the interpolar gap may be decreased to very low values (15-30 mm). The anode rack (100) and the cathode frame longitudinal bars (200) are reversibly fixed by means of bolts (205). This allows the concurrent insertion or extraction, by means of a suitable lifting means, of the two electrodic packages, anodic and cathodic. Likewise, the bolt withdrawal (205) permits, for instance, the handling of the cathode package alone. The advantages of a similar operative flexibility will be apparent to one skilled in the art: the cathode package, for instance, can be extracted as a single block to recover the product (whereas the prior art provides the individual recovery of the single cathodes), however without having to handle the more delicate anode package. As an alternative, the cathode package extraction and the positioning thereof on a different support may be convenient to carry out a maintenance operation to the anodes which remain positioned in the containing basin, and which result, following the cathode package withdrawal, easily accessible individually.

The longitudinal bars (200) may act at the same time as cell cathode bus-bar, or they may be directly connected to an external bus-bar, for instance made of copper.

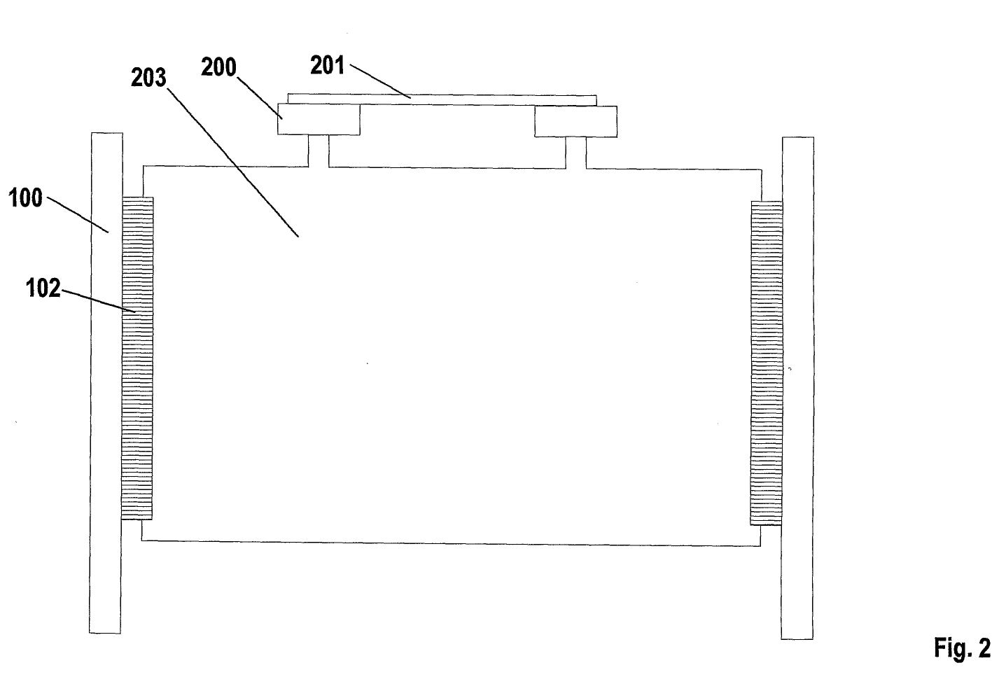

In a preferred embodiment, an equivalent anode bus-bar, electrically connected to the anode rack (100), is also present on the upper part of the cell, not shown. FIG. 2 shows a cathode(203) in a front-view, secured in two upper points to the cathode frame longitudinal bars (200). The insulating guides (102) are again shown, secured to the anode rack (100) and favouring the correct positioning and alignment thereof with respect to the adjacent anodes (not shown).

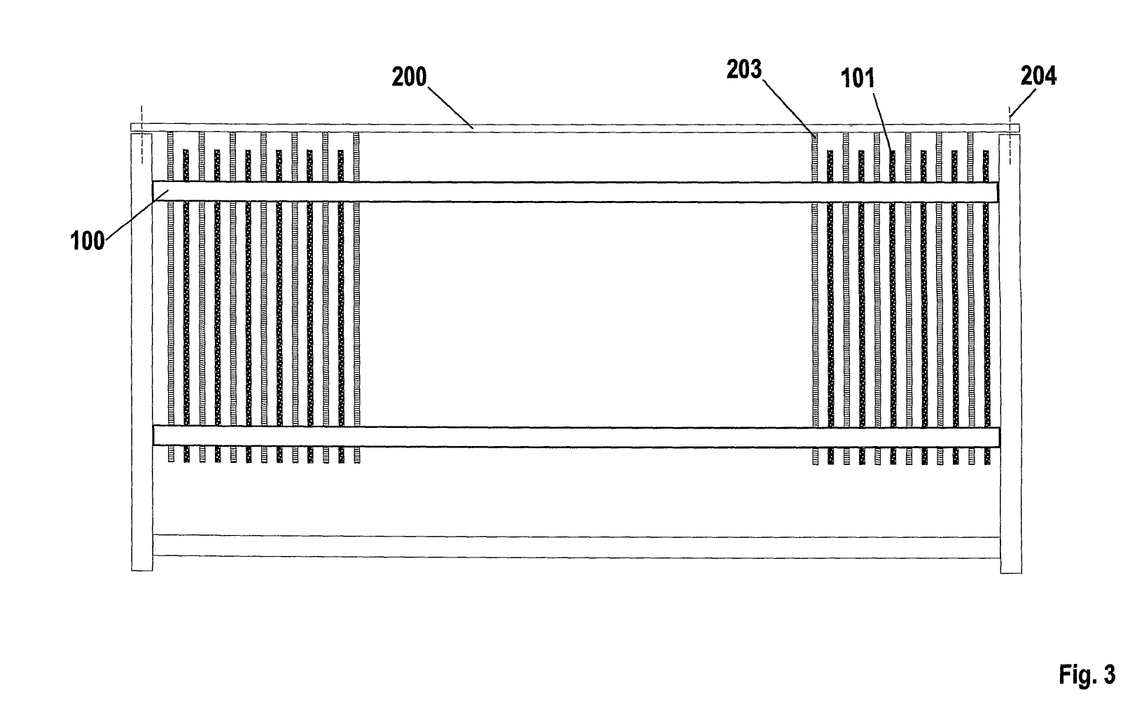

FIG. 3 shows a first embodiment of the cell of the invention; the common elements to the previous figures are identified by the same reference numerals. The illustrated structure, completely open on all sides, is suitable for being inserted into an external containing basin of adequate shape and size. The cell core, consisting of the electrode packages, results anyhow to be a structure easily removable from the basin delimiting the same; The containing basin is often a fixed installation of the relative electrochemical plant, while the structure shown in FIG. 3 can be constructed or subjected to catalytic reactivation and other types of maintenance in a site totally independent from the plant itself. In many cases, for example for electrometallurgical applications, basins previously employed with electrodes of the prior art can be reused by replacing the latter with the structure shown in FIG. 3.

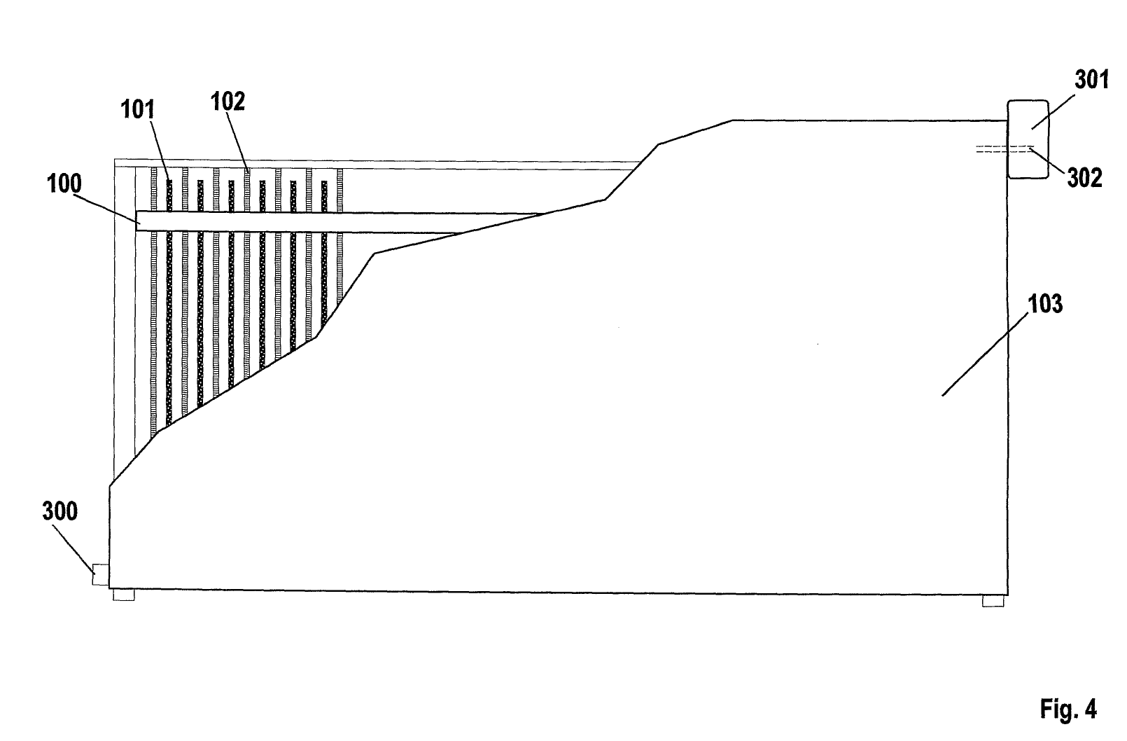

In other cases, the containing basin present on site may be a hopper tank, usually with conical bottom, with side-walls of reduced height. In this case, the cell of the invention may be constructed according to the embodiment shown in FIG. 4, wherein side-walls (103), for instance bolted to the anode rack (100), have been added to the elements displayed in FIG. 3. In FIG. 4 also other optional elements of the cell are shown, such as the feed nozzle (300) and the extraction manifold (301), fed from a preferably adjustable overflow (302) on the upper part of the cell; the electrochemical processes for which the cell is suited are in fact preferably carried out on an electrolyte circulated from bottom to top with a slow upward motion, exerting a mechanical action as reduced as possible on the cathode deposit. The adjustable overflow may serve to control the electrolyte internal motion, so as to make the distribution as uniform as possible, as known to those skilled in the art. In a preferred embodiment, the extraction manifold (301) is obtained within the same tubular making up the cell structure.

The cell of the invention is employed in all common processes of metal primary electrodeposition; the limited interelectrodic gap, with consequent decrease in cell voltage, and the high productivity allowed by the high active surface per unit volume make attractive in this case the use of noble metal oxide-activated titanium electrodes, more expensive than the traditional lead anodes but favoured by energy-saving considerations. The reduced resistive penalty may allow carrying out the process also at higher current densities than those of classic metal electrowinning (for example, 500 A/m² rather than 100 A/m²). The modular geometry of the electrode packages also permits the maximum operative flexibility in terms of productivity per cycle, since pairs of anodes and cathodes can be easily excluded from the process or reintegrated therein by operating the cell with a higher or lower number of electrodes, according to the production requirements. The cell finds another natural use in several water treatment processes, among which the softening of calcareous waters. In this case, it is particularly important that the cell be supplied with the water to be softened from the bottom, maintaining a slow upward circulation (indicatively, with residence times of 10-15 minutes) to obtain the desired product (that is the softened water, for instance with a calcium and magnesium content reduced by 90%) at the upper zone, preferably through an overflow feeding the upper outlet manifold. By means of controlled process conditions it can be prevented that the cathode deposit, consisting of carbonate as disclosed in the mentioned Patent application FR 2 743 800, be detached from the cathode surface contaminating the water once more. Nevertheless, even when this should happen, the water circulation with a very slow upward motion makes the deposit scales undergoing detachment fall down settling on the bottom of the containing basin, avoiding to mix up with the product.

The cathode surfaces can be periodically cleaned, for instance by mechanical means such as brushing, vibration induction and/or compressed air treatment, upon releasing the constraint (205) between anode rack (100) and cathode frame, and by lifting the cathode package alone.

As it is evident to one skilled in the art, the invention may be practiced making other variations or modifications to the reported examples.

The previous description is not intended to limit the invention, which may be used according to different embodiments without departing from the scopes thereof, and whose extent is univocally defined by the appended claims.

Throughout the description and claims of the present application, the term “comprise” and variations thereof such as “comprising” and “comprises” are not intended to exclude the presence of other elements or additives.

1. A finite interpolar gap undivided cell for electrochemical processes with anodic oxygen evolution, comprising an anode package consisting of vertical planar anodes secured to an anode rack and a cathode package consisting of vertical planar cathodes secured to a cathode frame and intercalated to said anodes, said anode rack and said cathode frame provided with means for the reciprocal fixing in a reversible fashion so as to alternatively allow the individual extraction of said cathode package or the concurrent extraction of said anode package and said cathode package.

2. The cell of claim 1 further comprising a lower feed manifold and an upper electrolyte outlet feed through an optionally adjustable overflow.

3. The cell of claim 1 comprising an anode bus-bar secured to the upper part of said anode rack.

4. The cell of claim 1 wherein said anodes comprise a titanium or valve metal substrate and a noble metal oxide-based catalytic coating for oxygen evolution.

5. The cell of claim 1 wherein said anodes are fixed to said anode rack in at least four points, two upper and two lower points.

6. The cell of claim 1 wherein said anode rack comprises insulating guides optionally of plastic material for aligning said cathodes in an intercalated position with respect to said anodes.

7. The cell of claim 1 wherein said planar cathodes are in form of stainless steel or nickel sheet.

8. The cell of claim 1 wherein said planar cathodes are secured to said cathode frame in at least two upper points in electrical connection with a cathode bus-bar.

9. The cell of claim 1 further comprising an external containing basin.

10. The cell of claim 1 further comprising containing side-walls fixed to said anode rack.

11. A metal electrowinning process comprising the electrolysis of a deposition bath by means of the cell of claim 1.

12. A water softening process comprising the microelectrolysis of waters containing calcium and/or magnesium carbonate fed from the bottom in the cell of claim 1, with deposition of said calcium and/or magnesium carbonate on said planar cathodes and extraction of softened water from the top.

13. The process of claim 12 comprising the periodic extraction of said cathode package and the subsequent removal of said calcium and/or magnesium carbonate deposited on said planar cathodes.

14. The process of claim 13 wherein said calcium and/or magnesium carbonate removal is carried out by mechanical means.
